(19) United States
(12) Patent Application Publication
(10) Pub. No.: US 2010/0005607 A1
(43) Pub. Date: Jan. 14, 2010

(54) Handle for cleaning implement

(76) Inventor: Eric DelaBarre, Santa Monica, CA (US)

Correspondence Address: Cislo & Thomas LLP, 1333 2nd Street, Suite #500, Santa Monica, CA, 90401-4110, US

(21) Appl. No.: 12/217,951

(22) Filed: Jul. 9, 2008

(51) Int. Cl. A46B 5/02; B25G 1/10

(52) U.S. Cl. 15/143.1; 16/430; 134/42

(57) ABSTRACT

A handle for a cleaning implement made of a plastics tubular material having a flexible loop shaped end with an oblong shape and an open end extending away from the loop end. The open end is sized and shaped to securely fit over the post end of a cleaning implement such as a broom, mop, brush, squeegee or rake. The shape and dimensions of the opening in the loop end accommodates a user's hand and arm, allowing the user to place his or her hand and forearm through the opening allowing the loop shaped end come to rest on the forearm. The user's hand then grips the post of the cleaning implement providing better leverage and control of the cleaning implement and allowing the user to flawlessly utilize a dust pan or similar object, move furniture, or maneuver the cleaning implement without repositioning the hand.

### TECHNICAL FIELD

The invention concerns an improved handle for a cleaning implement.

### BACKGROUND

Designs for broom, mop, and brush handles employ a generally uniform girth of material from the broom, mop, or brush end to the handle. The most common handles are merely straight and cylindrical in shape with uniform diameter. The cylinder of the straight handle may have varied girth to enhance grip. Other handles may have a zigzag, crooked shape designed to keep users upright while sweeping. These straight cylinder handles and the so-called “ergonomic” crooked handles both place the user in an uncomfortable position with no leverage to perform one-armed sweeping, brushing, or mopping motions. Instead, the user must have two hands on the handle to perform sturdy sweeping movements. On brooms and brushes with smaller handles, the entirely straight handle forces the user to put its wrist in an awkward position.

Not only is changing direction difficult, but performing related tasks while cleaning with the straight-handle implements is next to impossible without readjusting hand position or putting the implement down altogether. This wastes time and decreases cleaning efficiency. It is also less comfortable for the user to bend over or move to a place to set down or prop the implement while accomplishing a related task. For example, if the user is sweeping with two arms on the handle and it must move a chair or other object, it must place the cleaning implement such as a broom down or prop it precariously against another object, or remove his or her hands from the implement entirely and reposition them and then lift the broom along with the object.

The previous designs also make it difficult for a user to efficiently use a dustpan or other receptacle combined with the broom or mop because the user must reorient her hands and arms to move waste into the dustpan.

While some crooked handles may correct an alignment problem, the design does not resolve the inefficiency and awkwardness of the straight cylindrical handles. For example, using a crooked handle also requires the user to remove and reposition its hands when using other implements such as a dustpan, when moving objects such as chairs, or when maneuvering around objects such as furniture, stadium seats, and stairs. Crooked handles also do not remove the requirement that the user use two hands.

One-armed sweeping is virtually impossible and ergonomically ineffective for both straight handles and crooked handles. Use with one arm gives the user very little control over the force on the broom, can damage a user's wrist, and may be too heavy for some users.

Other handles may have rounded portions with a greater diameter than the cylindrical shaft to fit into a user's hands. The rounded portions may even be rubber with “nubs” to create a gripping surface; however, such portions still may require two hands or require the user to place the handle down when trying to move objects or accomplish related tasks such as using a dust pan. Using handles with rounded portions with one hand also does not provide the leverage needed to use a dust pan or to move waste and requires two hands or a mid-job readjustment of the hands to gather the waste.

In the case of all these handles, a one-armed motion is impossible to sweep, mop, and brush and accomplish other tasks such as gathering waste in a dustpan. It is also not possible to dip the implement into a bucket of cleaning material or other receptacle without readjusting the grip or tweaking the grip in a dangerous ergonomic and uncomfortable position. In fact, a one-armed motion may cramp the arm and wrist.

A user tightening his or her hold on previous handle designs does not necessarily get greater control of the implement because the force is not properly distributed to the end of the implement through the handle. All fingers clamping on a straight cylindrical shaft, a crooked shaft, or a bulbous unit on either of these shafts do little against the forces that provide leverage to push waste into a dustpan.

Also, the prior designs may be too heavy for some users to lift with one arm as all handles require gripping with the hands and leave out other stronger portions of the arm. Mere gripping with the hands avoids the ability to use the strength of the forearm combined with the hands to maneuver cleaning implements. As a result, many users will tire easily or be discouraged from use of prior handle designs.

Thus, there is a need for a handle that provides a design allowing for a one-arm, one-handed hold on the cleaning implement for maximum grip, control, and leverage that can keep a user working efficiently, effectively, and safely without injury far longer than current cleaning implement handles.

### SUMMARY

The present invention is a handle for a cleaning implement that provides a unique design for a one-arm, one-handed hold on the cleaning implement. The inventive design accomplishes maximum leverage, control, and grip for users such that cleaning becomes efficient, effective, and safe. The inventive handle is designed to fit removeably or fixedly on a cleaning implement having a post end and a utility end such as a broom, mop, or brush. The utility end may also be a squeegee or rake. The inventive handle fits removeably or fixedly on, around, or in the post end of a cleaning implement. The inventive handle comprises a tubular handle member having a loop shaped end with an opening in the loop end sized to loosely fit around a human hand and arm. Extending away from the loop end is an open end. The open end preferably has a diameter slightly larger than the post end of a cleaning implement and is shaped to fit snugly on, around, or in the post end of the cleaning implement. The post end of the cleaning implement is preferably of a length so that the user may stand while using the implement and the utility end of the implement comes in contact with the floor.

All cleaning implements may be configured for, and of a material for, wet or dry use, indoor or outdoor use, and/or commercial or household use. For example, for wet use, a mop may have a spongy surface capable of absorbing liquid such as water and cleaning material or may have a plurality of twisted strands capable of absorbing liquid. A broom suitable for wet use may be rubber or other synthetic or natural material capable of moving liquid. For dry use, a mop may have a soft, felt-like surface, or a broom may have firm bristles made of synthetic or natural material such as bamboo or tree twigs, stiff grasses, hay or corn husks.

The inventive handle for a cleaning implement may be formed of a material such as a plastics material or other synthetic or semi-synthetic material, metal, wood, or bamboo with a loop shape, the loop end being either an entirely closed loop or a partially open loop. If the loop is partially open it has a hook shape or an exaggerated hook shape. The material may be flexible, malleable, and conformable but firm enough to hold its shape. In a preferred embodiment, it is made of a material that is flexible, malleable, and conformable to a user's arm and grip, but firm enough to hold its shape when in use or when not in use. The loop end may be oblong, or oval, or any shape having a rounded end capable of cradling a user's forearm. The shape of the loop must be large enough to fit a human hand and forearm as the user will slide his or her hand and forearm through the loop and have the loop come to rest on the forearm. The hand then grips the post portion of the cleaning implement or the open end of the inventive handle extending away from the loop end. The user's hold configuration effectively provides the leverage, control, and grip necessary to maneuver the cleaning implement and use it in connection with other cleaning tools such as a dust pan, bucket, or other receptacle.

In one embodiment, the loop end is positioned at an angle in relation to the cleaning implement. For example, if the cleaning implement was flat in a plane, the loop end may slightly rise up out of the plane at an angle of about ten (10) degrees to forty-five (45) degrees. Preferably the angle is less than forty-five (45) degrees. This angled orientation facilitates the user's hold providing greater leverage, control, and grip on the cleaning implement. The angled orientation also increases the maneuverability of the cleaning implement and aids use in connection with other cleaning tools such as a dust pan, bucket, or other receptacle. When the loop end is in an angled position, it may be positioned such that it sits comfortably on and around a user's arm.

In yet another embodiment, the loop end may be slightly twisted in relation to the axis formed by the post end of the cleaning implement. If the cleaning implement is flat in a plane, the loop end is rotated from about ten (10) degrees to about forty-five (45) degrees from the axis formed by the post end of the cleaning implement. This twisted orientation of the loop end facilitates the user's hold by providing greater leverage, control, and grip on the cleaning implement. The twisted orientation also increases the maneuverability and aids use in connection with other cleaning tools such as a dust pan, bucket, or other receptacle. When the loop end is in a twisted position, it sits comfortably on and around a user's arm.

In yet another embodiment, the loop end may be at an angled and twisted position to facilitate the user's hold by providing greater leverage, control, and grip. The angle and twist orientation combination increases the maneuverability and aids use in connection with other cleaning tools such as a dust pan, bucket, or other receptacle. When the loop end is in the angled and twisted position, it sits comfortably on and around a user's arm.

In another embodiment, the loop end may include a soft piece of material such as foam, felt, shearling, lambswool, batting covered by a sheath of fabric, moleskin, rawhide, kidskin, or other soft or padded material. The soft piece of material is inserted on the inside portion of the loop under the curved opening. This provides extra padding and extra comfort for a user when the loop end of the handle rests on the user's forearm. It may also provide some friction to keep the handle in place or to keep the handle from slipping off the arm.

The open end of the inventive handle has a diameter slightly larger than the post end of the cleaning implement so that the open end extending away from the loop end fits snugly around the post end of the cleaning implement. The snug fit may be achieved by friction, a ribbed inside of the open end, a clamp or clasp surrounding the outside of the open end with a lever or clip to cinch the open end over the post end of the cleaning implement. For example, the open end may have a friction fit piece inside the open end to secure the handle over the post of the cleaning implement. The open end may fit over 1.0 inches to 10.0 inches of the post of the cleaning implement to ensure secure placement on the cleaning implement. In one embodiment, the handle comprises a clip around the outside of the open end, the clip may also have a hinge tab to cinch the clip around the outside of the open end to secure the handle to the post of the cleaning implement. In yet another embodiment, the handle has a clip around the outside of the open end with a twist tab capable of pivoting to cinch the clip around the outside of the open end to secure the handle of the post of the cleaning implement. In another embodiment, the open end may have a threaded inside so that the inventive handle may be securely screwed around the post end of a cleaning implement. All options and configurations are shaped and designed so that the handle may optionally be used interchangeably with multiple different cleaning implements, or may be sold as a single handle. Alternatively, the handle may be fixed to the cleaning implement by an adhesive, weld, or other fastening and may be sold together with the cleaning implement as one unit.

It is to be understood that the “open” end of the handle is described as such so that it may be attached to removeaby or fixedly to the post of a cleaning implement, therefore, upon attachment the end will not be “open” but rather will fit securely on the cleaning implement.

The tubular handle member may be hollow or solid on the inside and may have a diameter of about 0.1 inch to 2 inches, preferably about 0.5 inch to 1.5 inches. The lower opening of the loop end closest to the open end may define an angle of approximately 25 to 50 degrees, preferably 30 to 45 degrees. The length of the handle from the open end to the apex of the loop end may measure between approximately 10.0 inches and approximately 28.0 inches and the width of the widest part of the loop end may measure between approximately 0.5 inch and approximately 12.0 inches. In yet another embodiment, the length of the handle may measure between approximately 12.0 inches and approximately 24.0 inches and the width may measure between approximately 1.0 inches and approximately 8.0 inches. The open end of the tubular handle member may extend from the loop end about 2.0 inches to about 10.0 inches.

The tubular handle member may have a smooth, grooved, or friction surface, or a surface with nubs. If it has nubs, the nubs may rise from the surface of the tubular handle member no more than 0.5 inches. The texture of the plastics material may enhance friction on a user's arm and prevent slipping.

The unique shape of the loop end provides numerous advantages to the user. For example, the user when inserting his or her hand through the loop and allowing it to rest on the forearm, and then gripping the cleaning implement or lower open end of the inventive handle, can maintain a secure grip on the implement with maximum leverage to perform a sweeping, mopping, or brushing motion. Also, the user has the best leverage for one-armed, one-handed task mastering and can utilize complementary cleaning instruments such as a dust pan, bucket, or cleaning solution all the while maintaining the secure hold with the arm through the loop and on the cleaning implement. No repositioning of the hands is necessary. Also, the user does not have to reposition the hands or place the implement down to move furniture or obstacles such as chairs and tables, and maintains ultimate maneuverability around fixed objects or hard to reach places such as in small coffee shops, crowded stores, school rooms, stadiums, movie theaters, and in apartments and homes.

The force of the forearm and hand have greater distribution on the cleaning implement, and users of all strengths and sizes can keep the cleaning implement in use efficiently and effectively such that jobs are completed better and faster, with safe user alignment and stability.

The curvature of the loop end farthest away from the open end of the tubular handle member rests easily on human forearms of all shapes and sizes, allowing the unique hold of the cleaning implement through the loop and then onto the post end of the implement or the lower, open end of the handle.

The handle of the present invention is intended for cleaning implements with a long post end and a utility end such as a broom, mop, brush, squeegee, or rake. All implements may be configured and of a material for wet and dry use, indoor and outdoor use, and/or commercial and household use. For example, if the utility end has fibers, the fibers may be soft or firm, angled, made of bristles from corn husks or of a synthetic or semi-synthetic material. The post end of the cleaning implement may have an adjustable height shaft that adjusts to fit the user and the job or it may be fixed.

The post end of the cleaning implement is of a length such that when using the inventive handle attached to a cleaning implement, the user may stand and have the utility end of the cleaning implement reach the floor. For example, the post end may have a length from about 2.0 feet to 6.0 feet, preferably from about 3.0 feet to 5.0 feet. The post end has a top and bottom. The top of the post end is attached to the open end of the handle and the bottom of the post end is attached to a utility end such as a broom, mop, or brush.

Also contemplated by the present invention is a method of using the inventive handle on the end of a cleaning implement comprising inserting a hand and arm through the loop end of the handle grasping the open end of the handle with the arm and letting the loop end come to rest on the arm, moving the arm with the handle attached to exert force on the cleaning implement in a sweeping, mopping, brushing, or raking motion. A sweeping motion includes back and forth swinging of an implement over a surface to gather any waste or loose material on the surface. If sweeping, the method further comprises holding a dust pan in the free arm and moving the handle and arm in a sweeping motion to gather waste and move it into the dust pan. If mopping or brushing, the method may further comprise dipping the cleaning implement into a receptacle filled with a liquid cleaning material.

These objects, as well as other objects and advantages of the present invention, will become clearer through consideration of the following description and accompanying designs.

### BRIEF DESCRIPTION OF THE DRAWINGS

FIG. 1 is a perspective view of an embodiment of the handle of the present invention shown attached to a broom cleaning implement;

FIG. 2 is an enlarged perspective view of the handle;

FIG. 3 is a top down view of an embodiment of the handle;

FIG. 4 is side view of an embodiment of the handle;

FIG. 5 is a perspective view of an embodiment of the handle shown in use attached to a broom cleaning implement.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the features of the invention in connection with the illustrated embodiments. It is to be understood, however, that the same or equivalent functions and sequences may be accomplished by different embodiments that are also intended to be encompassed within the spirit and scope of the invention.

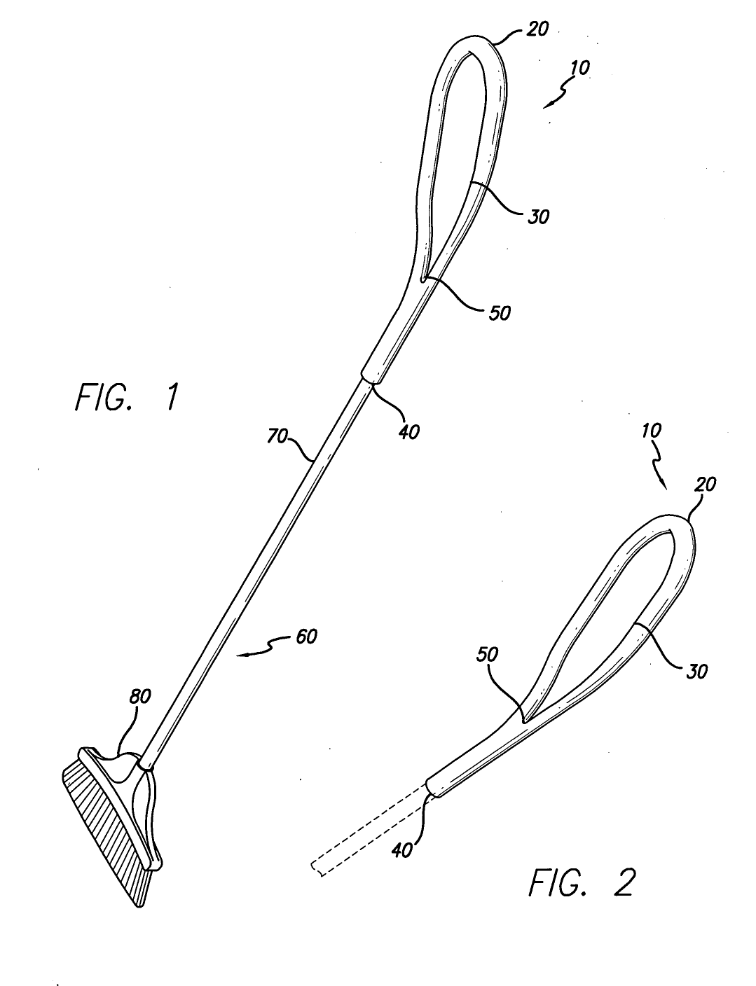

FIG. 1 depicts a perspective view of one embodiment of the handle of the present invention comprising a tubular handle member 10 having a loop end 20 for resting on the forearm, an opening in the loop end 30 on the inside of the loop end, an open end 40 extending away from the loop end 20, and an angle 50 on the inside of the loop end 20 closest to the open end 40 defining angle of less than ninety (90) degrees, preferably from about fifteen (15) to fifty-five (55) degrees, wherein the handle 10 is attached fixedly, or removeably to a cleaning implement 60 with a long post end 70 and utility end 80 such as a broom shown in the perspective view. The opening in the loop 30 is shaped to receive a human hand and forearm such that a user places his or her hand through the opening in the loop 30, rests the top of the loop end 20 on his or her forearm, and then grips the tubular handle member 10 either on the open end 40 or on the post end 70 of the cleaning implement 60. The cleaning implement 60 shown has a utility end 80 that is a broom. Other utility ends may be a mop, and all may be of a material capable of wet or dry use.

In one embodiment, the angle 50 in tubular handle member 10 on the inside of the loop end 20 closest to the open end 40 defines angle of less than ninety (90) degrees, preferably from about fifteen (15) to fifty-five (55) degrees. The position of the angle is such that an imaginary center line dissecting the loop end also equally dissects the angle. Such positioning may assist in enhancing leverage on the cleaning implement and perfects a user's one-handed, one-armed grip, thereby maximizing maneuverability and efficiency.

FIG. 2 depicts an enhanced perspective view of one embodiment of the inventive handle 10 alone. As shown, the handle comprises a tubular handle member 10 having a loop end 20 for resting on the forearm where the loop end 20 is at an angle from about ten (10) to forty-five degrees (45) above a plane set by the cleaning implement 60, an opening in the loop end 30 on the inside of the loop end, an open end 40 extending away from the loop end 20, and an angle 50 on the inside of the loop end 20 closest to the open end 40 defining an angle of less than ninety (90) degrees, preferably from about fifteen (15) to fifty-five (55) degrees, wherein the handle 10 may be attached fixedly, or removeably to a cleaning implement. The angle 50 may also be about fifteen (15) to thirty-five (35) degrees.

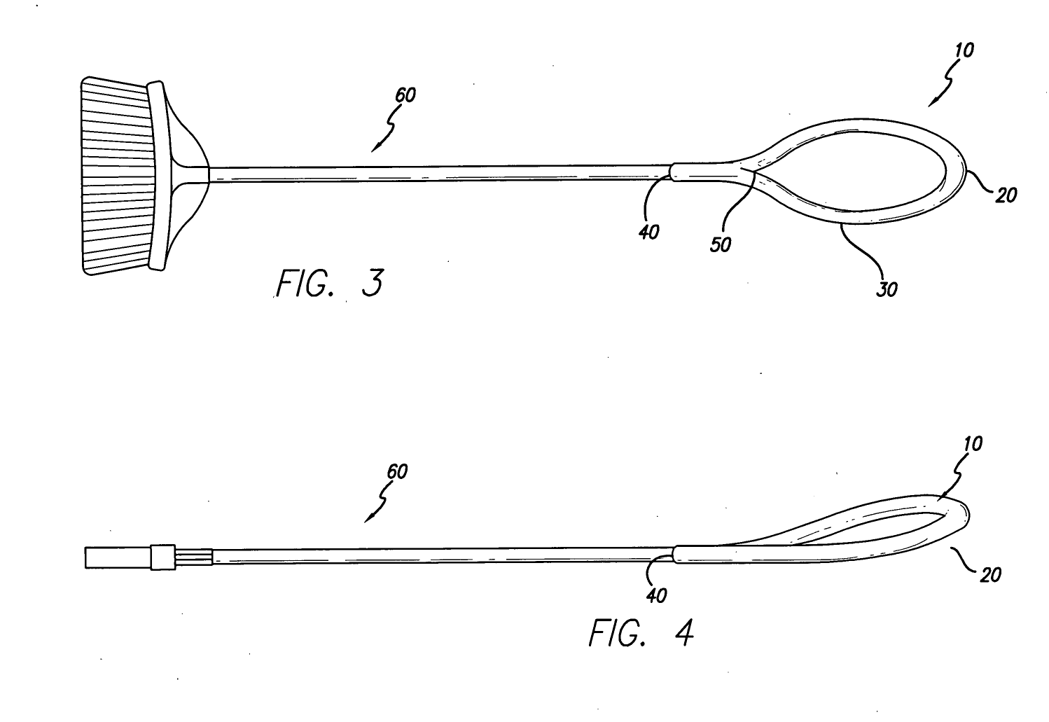

FIG. 3 depicts a top view of one embodiment of the inventive handle 10 alone. As shown, the handle comprises a tubular handle member 10 having a loop end 20 for resting on the forearm, where the loop end 20 is at an angle from about ten (10) to forty-five degrees (45) above a plane set by the cleaning implement 60, an opening in the loop end 30 on the inside of the loop end, an open end 40 extending away from the loop end 20, and an angle 50 on the inside of the loop end 20 closest to the open end 40 defining angle of less than ninety (90) degrees, preferably from about fifteen (15) to fifty-five (55) degrees, wherein the handle 10 may be attached fixedly, or removeably to a cleaning implement.

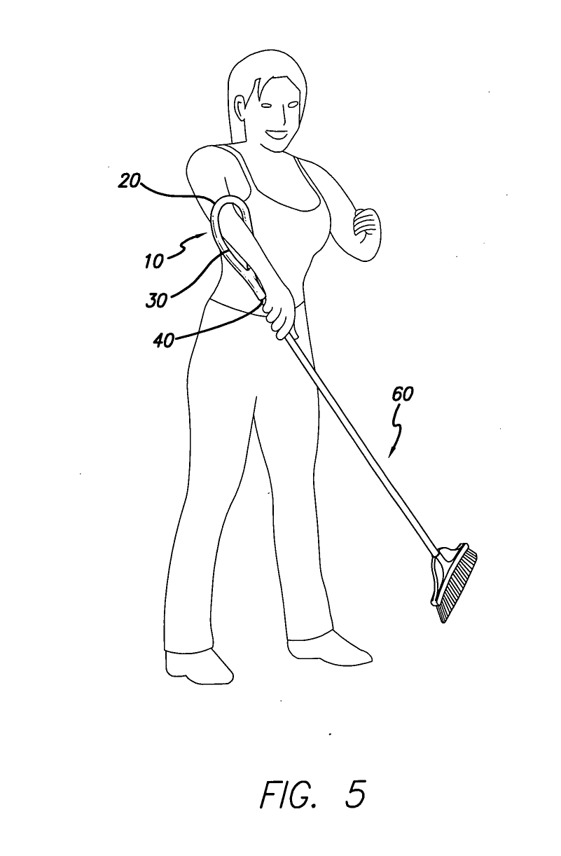

FIG. 4 depicts a side view of one embodiment of the inventive handle 10 alone. The figure shows the tubular handle member 10 having a loop end 20 with a twist of about ten (10) to forth-five (45) degrees from the axis set by the cleaning implement 60 and an open end 40 extending away from the loop end 20.

FIG. 5 depicts a perspective view of one embodiment of the inventive handle 10 in use attached to a broom 60. As shown, the tubular handle member 10 has a loop end 20 that rests on the user's forearm, an opening in the loop end 30 on the inside of the loop end where the user has threaded her hand through so that the loop end 20 rests on the forearm, and the hand grips the handle 10 and/or the cleaning implement 60 on or near the open end 40 extending away from the loop end 20. The angle 50 on the inside of the loop end 20 closest to the open end 40 is partially or wholly obscured by the user but is sized and shaped so that the loop end 20 forms a curve that comfortably rests on the user's forearm. It need not securely hug the forearm, but may, and it may loosely fit on the arm so that users of all shapes, sizes, and strengths may use the inventive handle attached to any cleaning implement.

In some embodiments, the loop end 20 may partially open so as to form a hook; however, in all embodiments, the loop end 20 will be flexible, contoured, and of an angle capable of coming to rest on a user's arm when it is holding a cleaning implement having a long post end and a utility end such as a broom or mop. If the loop end 20 is partially open, the opening 30 will not be fully enclosed by the loop end 20 of the tubular handle member 10.

Also, in some embodiments, the open end 40 will have an inside adapted for a friction fit on the cleaning implement 60 such as with grooves or other gripping shape. The open end 40 may also have a clip around the outside so as to cinch the open end 40 securely to the cleaning implement 60. While no clip or other cinching mechanism is shown in the figures, the clip or cinching mechanism may further comprise a secure tab, a hinged tab, a twist piece, and/or other external, tightening and fastening structure to tighten it around the cleaning implement 60.

The material of the inventive handle 10 may be a flexible plastics material, synthetic or semi-synthetic, and/or a recycled material that is smooth, grooved, or with nubs.

When a cleaning implement comprising the inventive handle is in normal use, the arm will be positioned as shown in FIG. 5.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A handle for a cleaning implement having a post end with a top and a bottom, and a utility end capable of fitting around a human hand and arm comprising:
a. a tubular handle member formed of a flexible plastics material having a loop end, the loop end having an oblong shape and sized to loosely fit around the human hand and arm and an open end extending away from the loop end;
b. the open end having a diameter slightly larger than the post end of the cleaning implement;
c. the open end shaped to fit snugly around the top of the post end of the cleaning implement;
d. and the bottom of the post end of the cleaning implement attached to the utility end, the post end having a length of about 2.0 feet to 6.0 feet; wherein the utility end of cleaning implement is a broom.

2. The handle of claim 1, wherein the tubular handle member is hollow on the inside and has a diameter of about 0.5 inch to 1.5 inches.

3. The handle of claim 1, wherein the loop end further comprises a soft piece of material such as foam on the inside of the loop end.

4. The handle of claim 1, wherein the loop end is twisted in relation to an axis formed by the post end of the cleaning implement wherein the loop end is rotated from about ten (10) degrees to forty-five (45) degrees from the axis formed by the post end of the cleaning implement.

5. The handle of claim 1, wherein
a. the length from the open end to the apex of the loop end measures between approximately 10.0 inches and approximately 28.0 inches; and
b. the width at the widest part of the loop end measures between approximately 0.5 inch and approximately 12.0 inches.

6. The handle of claim 5, wherein
a. the length from the open end to the apex of the loop end measures between approximately 12.0 inches and approximately 24.0 inches; and
b. the width at the widest part of the loop end measures between approximately 1.0 inches and approximately 8.0 inches.

7. The handle of claim 1, wherein the tubular handle member has a surface comprising nubs.

8. The handle of claim 7, wherein the nubs on the tubular handle member rise from the surface of the tubular handle member no more than 0.5 inch.

9. The handle of claim 1, wherein the tubular handle member has a smooth surface.

10. The handle of claim 1, wherein the tubular handle member has a grooved surface.

11. The handle of claim 1, wherein the open end extends from the loop end about 2.0 inches to about 10.0 inches.

12. The handle of claim 1, wherein the open end has a friction fit piece inside the open end to secure the handle over the post of the cleaning implement.

13. The handle of claim 12, wherein the open end fits over 1.0 inches to 10.0 inches of the post of the cleaning implement.

14. The handle of claim 1, wherein the handle further comprises a clip around the outside of the open end.

15. The handle of claim 1, wherein the handle further comprises a clip having a hinge tab to cinch the clip around the outside of the open end to secure the handle to the post of the cleaning implement.

16. The handle of claim 1, wherein the handle further comprises a clip with a twist tab to pivot and cinch the clip around the outside of the open end to secure the handle of the post of the cleaning implement.

17. A handle for a cleaning implement having a post end and a utility end comprising:
a. a tubular handle member formed of a plastics material having a surface comprising nubs and a loop end with an oblong hole in the loop end sized to loosely fit around a human hand and arm and an open end extending away from the loop end;
b. the open end having a diameter slightly larger than the post end of the cleaning implement; and
c. the open end shaped to fit snugly around the post end of the cleaning implement;
wherein the utility end of the cleaning implement is a mop.

18. The handle of claim 17, wherein the loop end has an angled and twisted position in relation to the open end of the handle and the post end of the cleaning implement.

19. The handle of claim 17, wherein the mop is configured for wet use.

20. A method of using the handle of claim 1 on a cleaning implement comprising:
a. inserting a hand and arm through the loop end of the handle;
b. grasping the open end of the handle with the arm and letting the loop end come to rest on the arm; and
c. moving the arm with the handle attached to exert force on the post end of the cleaning implement to move the utility end which is a broom in a sweeping motion; and
d. holding a dust pan and moving the handle and arm in a sweeping motion to gather waste and move it into the dust pan.
